(19) United States
(12) Patent Application Publication
(10) Pub. No.: US 2014/0237422 A1
(43) Pub. Date: Aug. 21, 2014

(54) INTERPRETATION OF PRESSURE BASED GESTURE

(71) Applicant: FLATFROG LABORATORIES AB, Lund (SE)

(72) Inventors: Nicklas OHLSSON, Bunkeflostrand (SE); Andreas OLSSON, Bjarred (SE)

(73) Assignee: FLATFROG LABORATORIES AB, Lund (SE)

(21) Appl. No.: 14/176,424

(22) Filed: Feb. 10, 2014

Related U.S. Application Data
(60) Provisional application No. 61/765,158, filed on Feb. 15, 2013.

(51) Int. Cl. G06F 3/0484; G06F 3/0488; G06F 3/01

(52) U.S. Cl. CPC G06F 3/04845; G06F 3/017; G06F 3/0488
USPC 715/800

(57) ABSTRACT

The disclosure relates to a method whereby a user is provided with a gesture for e.g. editing work on a touch sensing device. By using two objects, e.g. two fingers, on a touch surface of the touch sensing device the user may zoom in or zoom out of a graphical element, halt the zooming, and thereafter crop the graphical element to define a new cropped element of the graphical element. The method makes use of a distance between the two objects, which is determined and monitored. The disclosure also relates to a gesture interpretation unit and to a touch sensing device.

This application claims priority under 35 U.S.C. §119 to U.S application No. 61/765,158 filed on Feb. 15, 2013, the entire contents of which are hereby incorporated by reference.

### FIELD OF THE INVENTION

The present invention relates to interpretation of certain inputs on a touch sensing device, and in particular to interpretation of gestures comprising pressure or force.

### BACKGROUND OF THE INVENTION

Touch sensing systems (“touch systems”) are in widespread use in a variety of applications. Typically, the touch systems are actuated by a touch object such as a finger or stylus, either in direct contact, or through proximity (i.e. without contact), with a touch surface. Touch systems are for example used as touch pads of laptop computers, in control panels, and as overlays to displays on e.g. hand held devices, such as mobile telephones. A touch panel that is overlaid on or integrated in a display is also denoted a “touch screen”. Many other applications are known in the art.

To an increasing extent, touch systems are designed to be able to detect two or more touches simultaneously, this capability often being referred to as “multi-touch” in the art.

There are numerous known techniques for providing multi-touch sensitivity, e.g. by using cameras to capture light scattered off the point(s) of touch on a touch panel, or by incorporating resistive wire grids, capacitive sensors, strain gauges, etc into a touch panel.

WO2011/028169 and WO2011/049512 disclose multi-touch systems that are based on frustrated total internal reflection (FTIR). Light sheets are coupled into a panel to propagate inside the panel by total internal reflection (TIR). When an object comes into contact with a touch surface of the panel, the propagating light is attenuated at the point of touch. The transmitted light is measured at a plurality of outcoupling points by one or more light sensors. The signals from the light sensors are processed for input into an image reconstruction algorithm that generates a 2D representation of interaction across the touch surface. This enables repeated determination of current position/size/shape of touches in the 2D representation while one or more users interact with the touch surface. Examples of such touch systems are found in U.S. Pat. No. 3,673,327, U.S. Pat. No. 4,254,333, U.S. Pat. No. 6,972,753, US2004/0252091, US2006/0114237, US2007/0075648, WO2009/048365, US2009/0153519, WO2010/006882, WO2010/064983, and WO2010/134865.

In touch systems in general, there is a desire to not only determine the location of the touching objects, but also to estimate the amount of force by which the touching object is applied to the touch surface. This estimated quantity is often referred to as “pressure”, although it typically is a force. Examples of touch force estimation in connection to a FTIR based touch-sensing apparatus is disclosed in the Swedish application SE-1251014-5. An increased pressure is here detected by an increased contact, on a microscopic scale, between a touching object and a touch surface with increasing application force. This increased contact may lead to a better optical coupling between the transmissive panel and the touching object, causing an enhanced attenuation (frustration) of the propagating radiation at the location of the touching object.

The touch technology gives the possibility to use new gestures for controlling different functions or graphical objects on a touch screen. The use of gestures may simplify work for users in different professions or in their hobbies. For example may the user make use of the touch technology when editing photos or other graphical objects. If an input device such as a mouse shall be used for editing, a lot of the user experience is lost and it is only possible to point at one location at the same time. If the user instead directly can interact with the graphical objects with his or her fingers the editing becomes more intuitive and may also become faster. From e.g. U.S. Pat. No. 8,238,784B2 it is known to zoom in and out of a graphical object using two fingers. For the editing purpose it might be a desire to also choose a certain area of the graphical object.

The object of the invention is thus to provide a gesture to enable editing work using touch technology, wherein the gesture includes pressure.

### SUMMARY OF THE INVENTION

According to a first aspect, the object is at least partly achieved with a method according to the first independent claim. The method comprises receiving touch input data indicating touch inputs on a touch surface of a touch sensing device, and determining from said touch input data:
a first touch input from a first object at a first position on the touch surface, and
a second touch input from a second object at a second position on the touch surface and while continuous contact of the first and second objects with the touch surface is maintained:
determining from the touch input data a distance d₁ between the first and second objects, and increasing the size of a first area of a graphical element visible via the touch surface if the distance increases, and decreasing the size of the first area of graphical element if the distance decreases;
determining from the touch input data that an increased pressure compared to a threshold of at least one of the first and second touch inputs has occurred, and thereby:
halting the increasing or the decreasing the size of the first area of the graphical element; and
determining a distance d₂ between the first and second objects;
determining from said touch input data that the distance between the first and second objects has decreased compared to the distance d₂, and
cropping the first area of the graphical element in relation to the decrease of the distance, whereby a cropped element of the graphical element is defined.

With the method, the user is provided with a tool, i.e. a gesture, to make layout work, image editing, etc more efficient and easy when working on a touch sensing device capable of sensing multiple simultaneous touches. With the method, the user can enlarge (zoom in) a certain detail in an image, i.e. a graphical element, and crop it such that a new image is defined with the enlarged detail. The enlarged detail, i.e. the cropped element, may then be transferred to another place, e.g. to a place in an album or newspaper.

By increasing the size of the first area is meant zooming into the first area. By decreasing the size of the first area is meant zooming out of the first area. Thus, the scale of the first area is changed. In other words, the perspective of the first area is changed. The zooming is according to one embodiment geometric zooming, i.e. where objects in the first area changes according to their size. According to another embodiment, the zooming is semantic zooming, where objects in the first area are changed according to their size and in addition modifies the selection and/or structure of data being displayed. Semantic zooming is typically used for maps.

According to one embodiment, the method comprises cropping the first area of the graphical element in relation to the attained decreased distance upon determining from the touch input data that an increased pressure compared to a threshold of at least one of the first and second touch inputs has occurred. Thus, the user can choose when the cropped element shall be defined by pressing on the touch surface.

According to another embodiment, the method comprises cropping the first area of the graphical element in relation to the attained decreased distance upon determining from said touch input data that at least one of the first and second objects is not present anymore on the touch surface. Thus, the user can choose when the cropped element shall be defined by lifting the first and/or the second object from the touch surface.

According to a further embodiment, the method comprises continuously cropping the first area of the graphical element in accordance with the decreased distance. Thus, the user will continuously see how the graphical element is cropped.

According to a further embodiment, the increasing or decreasing of the size comprises increasing or decreasing the size of the first area to a size based on the distance between the first and second objects. Thus, the first area may be increased or decreased in relation to the distance between the first and second objects. The increase or decrease of the size may directly correspond to the distance, or may be an increase or decrease scaled with a factor.

According to one embodiment, the method comprises visually indicating the first area. Thus, the first area may be highlighted to the user such that it is easily recognized. For example, visually indicating the first area comprises visually presenting the first area of the graphical element in relation to the cropped element of the graphical element. Thus, the cropped element can be easily recognized in relation to the rest of the graphical element, if any.

According to a second aspect, the object is at least partly achieved with a gesture interpretation unit comprising a processor configured to receive a touch signal sₓ comprising touch input data indicating touch inputs on a touch surface of a touch sensing device, the gesture interpretation unit further comprising a computer readable storage medium storing instructions operable to cause the processor to perform operations comprising determining from said touch input data:
a first touch input from a first object at a first position on the touch surface, and
a second touch input from a second object at a second position on the touch surface; and while continuous contact of the first and second objects with the touch surface is maintained:
determining from said touch input data a distance d₁ between the first and second objects, generating a first signal for increasing the size of a first area of a graphical element visible via the touch surface if the distance increases, and generating a second signal for decreasing the size of the first area of the graphical element if the distance decreases;
determining from said touch input data that an increased pressure compared to a threshold of at least one of the first and second touch inputs has occurred, and thereby:
halting generating any of the first and the second signal for increasing and decreasing the size of the first area of the graphical element, respectively;
determining a distance d₂ between the first and second objects;
determining from said touch input data that the distance between the first and second objects has decreased compared to the distance d₂, and
cropping the first area of the graphical element in relation to the decrease of the distance, whereby a cropped element of the graphical element is defined.

The gesture interpretation unit thus receives touch data with information of touches on the touch surface, and if the touch data has certain characteristics, the gesture interpretation engine generates signals to make the selected graphical element react in certain ways to the touch data. The user is now provided with a gesture for simplify editing etc.

The gesture interpretation unit preferably comprises instructions for generating the first signal for increasing the size of the first area to a size defined by the positions of the first and second objects, and instructions for generating the second signal for decreasing the size of the first area to a size defined by the positions of the first and second objects. As understood, the gesture interpretation unit may comprise instructions for generating a plurality of other signals for manipulating the graphical element, for cropping, for visually presenting the cropped element on the touch surface etc.

Also, several users may interact with different graphical elements at the same time on the same GUI and touch surface.

When in the description it is referred to a pressure, it can equally mean a force.

According to a third aspect, the object is at least partly achieved with a touch sensing device comprising:
a touch arrangement comprising a touch surface, wherein the touch arrangement is configured to detect touch inputs on the touch surface and to generate a signal s_{y} indicating the touch inputs;
a touch control unit configured to receive the signal s_{y} and to determine touch input data from said touch inputs and to generate a touch signal sₓ indicating the touch input data;
a gesture interpretation unit according to any of the embodiments as described herein, wherein the gesture interpretation unit is configured to receive the touch signal sₓ.

According to one embodiment, the touch sensing device is an FTIR-based (Frustrated Total Internal Reflection) touch sensing device.

The positioning data may for example be a geometrical centre of a touch input. The pressure data may be the total pressure, or force, of the touch input. According to another embodiment, the pressure data is a relative pressure, or force.

According to a fourth aspect, the object is at least partly achieved with a computer readable storage medium comprising computer programming instructions which, when executed on a processor, are configured to carry out the method as described herein.

Any of the above-identified embodiments of the method may be adapted and implemented as an embodiment of the second, third and/or fourth aspects. Thus, the gesture interpretation unit may include instructions to carry out any of the methods as described herein.

Preferred embodiments are set forth in the dependent claims and in the detailed description.

### SHORT DESCRIPTION OF THE APPENDED DRAWINGS

Below the invention will be described in detail with reference to the appended figures, of which:

FIG. 1 illustrates a touch sensing device according to some embodiments of the invention.

FIG. 2 is a flowchart of the method according to some embodiments of the invention.

FIG. 3A-3F illustrates the gesture at various points of performance on a touch surface of a device when a graphical element is presented via the GUI of the device and is visible via the touch surface.

FIG. 4A illustrates a side view of a touch sensing arrangement.

FIG. 4B is a top plan view of an embodiment of the touch sensing arrangement of FIG. 4A.

FIG. 5 is a flowchart of a data extraction process in the device of FIG. 4B.

FIG. 6 is a flowchart of a force estimation process that operates on data provided by the process in FIG. 5.

### DETAILED DESCRIPTION OF PREFERRED EMBODIMENTS OF THE INVENTION

1. Device

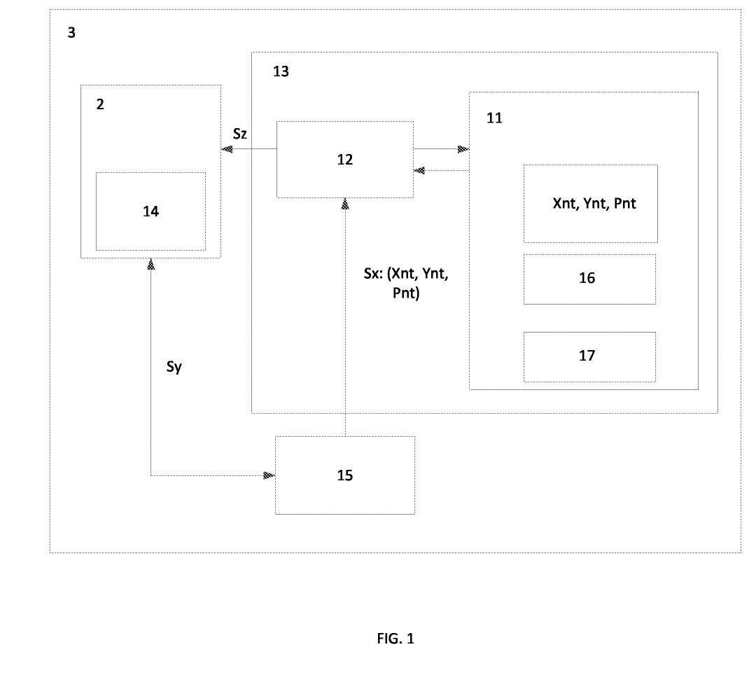

FIG. 1 illustrates a touch sensing device 3 according to some embodiments of the invention. The device 3 includes a touch arrangement 2, a touch control unit 15, and a gesture interpretation unit 13. These components may communicate via one or more communication buses or signal lines. According to one embodiment, the gesture interpretation unit 13 is incorporated in the touch control unit 15, and they may then be configured to operate with the same processor and memory. The touch arrangement 2 includes a touch surface 14 that is sensitive to simultaneous touches. A user can touch on the touch surface 14 to interact with a graphical user interface (GUI) of the touch sensing device 3. The GUI is the graphical interface of an operating system of the touch sensing device 3. According to one embodiment, the GUI is a zoomable user interface (ZUI). The device 3 can be any electronic device, portable or non-portable, such as a computer, gaming console, tablet computer, a personal digital assistant (PDA) or the like. It should be appreciated that the device 3 is only an example and the device 3 may have more components such as RF circuitry, audio circuitry, speaker, microphone etc. and be e.g. a mobile phone or a media player.

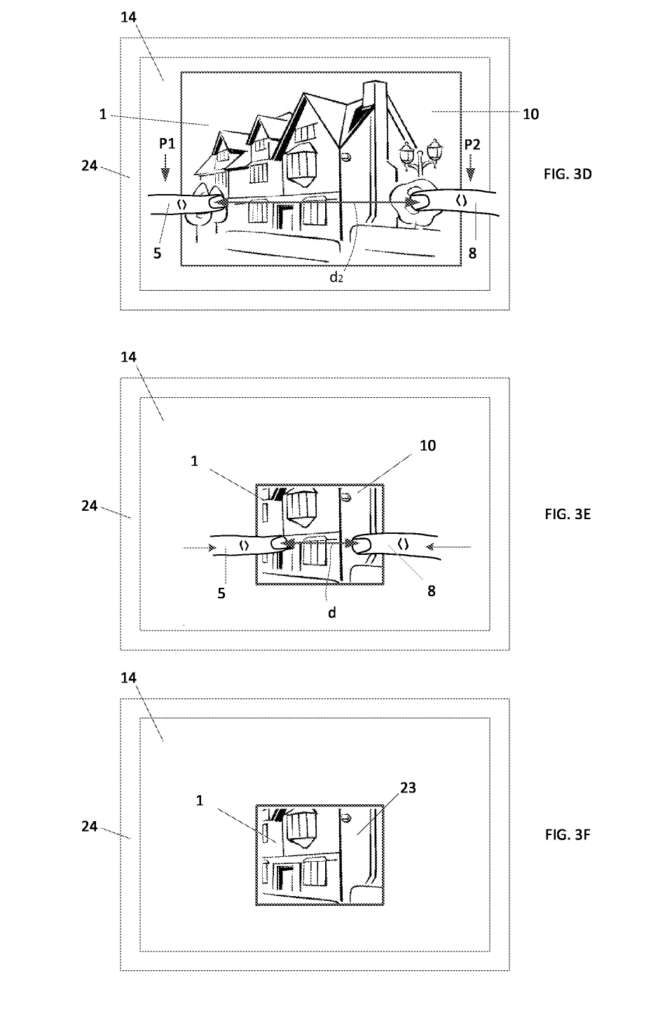

The touch surface 14 may be part of a touch sensitive display, a touch sensitive screen or a light transmissive panel 25 (FIG. 4A-4B). With the last alternative the light transmissive panel 25 is then overlaid on or integrated in a display and may be denoted a “touch sensitive screen”, or only “touch screen”. The touch sensitive display or screen may use LCD (Liquid Crystal Display) technology, LPD (Light Emitting Polymer) technology, OLED (Organic Light Emitting Diode) technology or any other display technology. The GUI displays visual output to the user via the display, and the visual output is visible via the touch surface 14. The visual output may include text, graphics, video and any combination thereof.

The touch surface 14 is configured to receive touch inputs from one or several users. A touch input is an interaction between a touch object and the touch arrangement 2. An “interaction” occurs when the touch object affects a parameter measured by a sensor as will later be exemplified. The touch arrangement 2, the touch surface 14 and the touch control unit 15 together with any necessary hardware and software, depending on the touch technology used, detect the touch inputs. The touch arrangement 2, the touch surface 14 and touch control unit 15 may also detect touch input including movement of the touch inputs using any of a plurality of known touch sensing technologies capable of detecting simultaneous contacts with the touch surface 14. Such technologies include capacitive, resistive, infrared, and surface acoustic wave technologies. An example of a touch technology which uses light propagating inside a panel will be explained in connection with FIG. 4A-4B.

The touch arrangement 2 is configured to generate and send the touch inputs as one or several signals s_{y} to the touch control unit 15. The touch control unit 15 is configured to receive the one or several signals s_{y} and comprises software and hardware to analyse the received signals s_{y}, and to determine touch input data including sets of positions xₙₜ, yₙₜ with associated pressure pₜ on the touch surface 14 by processing the signals s_{y}. Each set of touch input data xₙₜ, yₙₜ, pₙₜ, may also include identification, an ID, identifying to which touch input the data pertain. Here “n” denotes the identity of the touch input. If the touch input is still or moved over the touch surface 14, without losing contact with it, a plurality of touch input data xₙₜ, yₙₜ, pₙₜ with the same ID will be determined. If the touch input is taken away from the touch surface 14, there will be no more touch input data with this ID. Touch input data from a touch input may also comprise an area aₙₜ of the touch. A position xₙₜ, yₙₜ referred to herein is then preferably a centre of the area aₙₜ. A position may also be referred to as a location. The touch control unit 15 is further configured to generate one or several touch signals sₓ comprising the touch input data, and to send the touch signals sₓ to a processor 12 in the gesture interpretation unit 13. The processor 12 may e.g. be a computer programmable unit (CPU). The gesture interpretation unit 13 also comprises a computer readable storage medium 11, which may include a volatile memory such as high speed random access memory (RAM-memory) and/or a non-volatile memory such as a flash memory.

The computer readable storage medium 11 comprises a touch module 16 (or set of instructions), and a graphics module 17 (or set of instructions). The computer readable storage medium 11 comprises computer programming instructions which, when executed on the processor 12, are configured to carry out the method according to any of the steps described herein. These instructions can be seen as divided between the modules 16, 17. The computer readable storage medium 11 may also store received touch input data comprising positions xₙₜ, yₙₜ on the touch surface 14 and pressures pₜ of the touch inputs. The touch module 16 includes instructions to determine from the touch input data if the touch inputs have certain characteristics, such as being in a predetermined relation to each other and/or a graphical element 1, and/or if they are at a certain distance from each other, and/or if one or several of the touch inputs are moving, and/or if continuous contact with the touch surface 14 is maintained or is stopped, and/or the pressure of the one or several touch inputs. The touch module 16 thus keeps track of the touch inputs. Determining movement of a touch input may include determining a speed (magnitude), velocity (magnitude and direction) and/or acceleration (magnitude and/or direction) of the touch input or inputs.

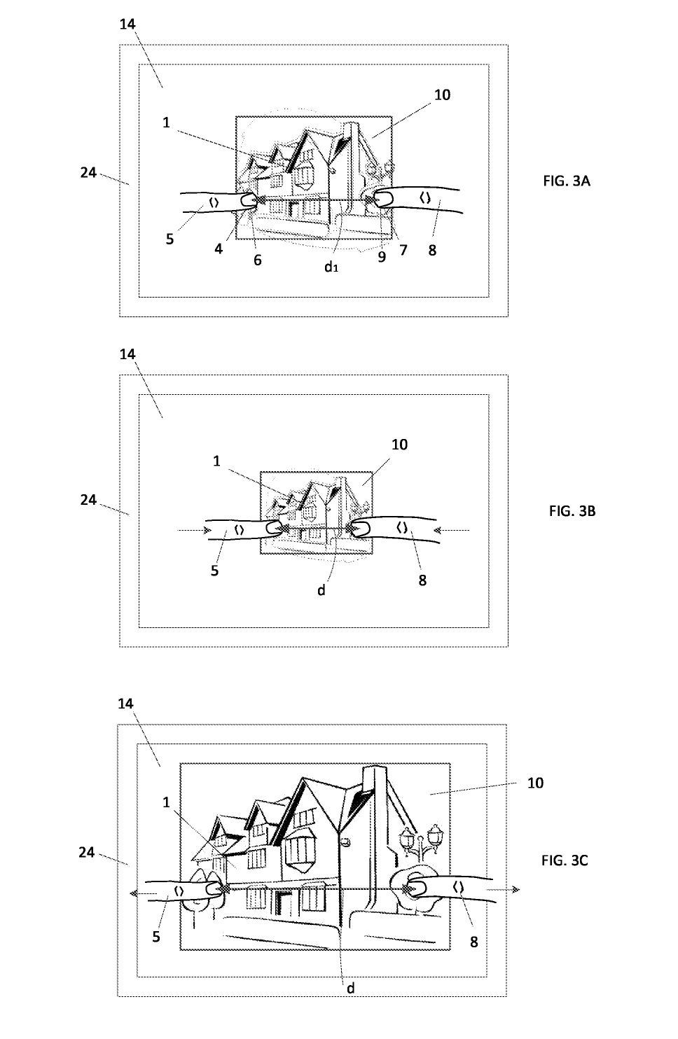

The graphics module 17 includes instructions for rendering and displaying graphics via the GUI. The graphics module 17 controls the position, movements, and actions etc. of the graphics. More specifically, the graphics module 17 includes instructions for displaying at least one graphical element 1 (FIG. 3A-3F) on or via the GUI and manipulate it and/or its graphical environment in response to certain determined touch inputs. The term “graphical” include any visual element that can be presented on the GUI and be visible for the user, such as text, icons, digital images or pictures, animations or the like. Thus, the touch module 16 is configured to determine fulfilment of the steps according to the herein described method, and upon fulfilment the graphics module 17 manipulates the associated graphical element 1, elements or the graphical environment of the graphical element 1 according to a certain action corresponding to the fulfilment, e.g. decrease or increase the size of the graphical element, crop a part of the graphical element 1, define a cropped element 23 etc. The processor 12 is configured to generate signals s_{z} or messages including the certain action. The processor 12 is further configured to send the signals s_{z} or messages to the touch arrangement 2, where the GUI via a display is configured to receive the signals s_{z} or messages and manipulate the graphical element 1, a first area 10, a cropped element 23 etc according to the certain action.

The gesture interpretation unit 13 may thus be incorporated in any known touch sensing device 3 with a touch surface 14, wherein the device 3 is capable of presenting the graphical element 1 via a GUI seen from the touch surface 14, detect touch inputs on the touch surface 14 and to generate and deliver touch input data to the processor 12. The gesture interpretation unit 13 is then incorporated into the device 3 such that it can process the graphical element 1 in predetermined ways when certain touch data has been determined.

2. Gesture

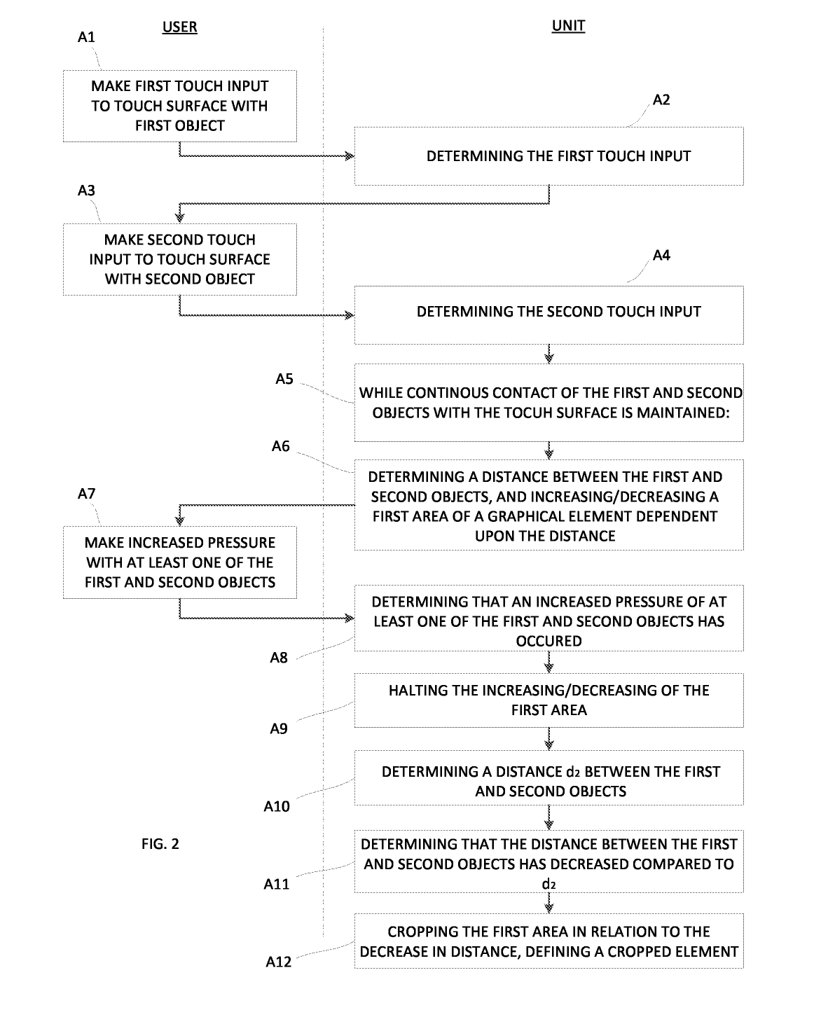

FIG. 2 is a flowchart illustrating a method according to some embodiments of the invention, when a user interacts with a graphical element 1 according to a certain pattern. The left side of the flowchart in FIG. 2 illustrates the touch inputs made by a user, and the right side of the flowchart illustrates how the gesture interpretation unit 13 responds to the touch inputs. The left and the right sides of the flowchart are separated by a dotted line. The method may be preceded by setting the touch sensing device 3 in a certain state, e.g. an editing state. This certain state may invoke the function of the gesture interpretation unit 13, whereby the method which will now be described with reference to FIG. 2 can be executed.

As a first step A1, the user makes a first touch input 4 to the touch surface 14 (FIG. 1) with a first object 5 at a first position 6. This touch input is detected by the touch control unit 15 (FIG. 1) and sent to the gesture interpretation unit 13 (FIG. 1) as a signal sₓ. The gesture interpretation unit 13 now has data from the first touch input 4 from the first object 5 at a first position 6 on the touch surface 14 (A2). The graphical element 1 may be presented on the touch surface 14 beforehand, or as a response to the first touch input 4. The graphical element 1 may be a graphical object such as a graphical picture, graphical image or any other kind of graphical object capable of being presented in a graphical environment of a computer. The graphical element 1 may also be defined to be a plurality of different graphical objects, or just a defined area of the GUI which is parallel with the area of the touch surface 14, including one or a plurality of different graphical objects or part of the object(s).

The user further makes a second touch input 7 to the touch surface 14 with a second object 8 (A3). The second touch input 7 from the second object 8 is then determined from the touch input data to be at a second position 9 on the touch surface 14 (A4). The first and second touch inputs 4, 7 do not have to come in a specific order as indicated in the flow chart of FIG. 2, but can instead be made, detected and determined simultaneously or in opposite order. If now the first and a second touch input 4, 7 have been determined, and continuous contact of the first and second objects 5, 8 with the touch surface 14 is maintained (A5) the gesture interpretation unit 13 monitors the touch data received for the first and second objects 5, 8 to determine if the rest of the steps of the method can be accomplished. According to the method, a distance d₁ between the first and second objects 5, 8 is determined, and a size of a first area 10 of a graphical element 1 visible via the touch surface 14 is increased if the distance increases, and the size of the first area 10 of graphical element 1 is decreased if the distance decreases (A6). The first area 10 may be an area of the touch surface 14 limited by the first and second positions 6, 9 of the first and second objects 5, 8. The first area 10 may instead be the actual area of the graphical element 1 in a xy-plane of a coordinate system of the graphical element 1. The xy-plane is e.g. parallel with the touch surface 14. Thus, according to some embodiments the positions 6, 9 of the first and second objects 5, 8 do not have to overlap with the graphical element 1. This is beneficial e.g. if the graphical element 1 is small and hard to touch on via the touch surface 14 with two objects 5, 8. In other embodiments the positions 6, 9 of the first and second objects 5, 8 do overlap with the graphical element 1. This is beneficial e.g. if the graphical element 1 is large compared to the touch surface 14. In other further embodiments, one position of the first and second positions 6, 9 overlaps with the graphical element 1 and the other one does not. The first area 10 may further have a circular shape, rectangular shape or any other shape.

The first area 10 may be an area limited by the first and second positions 6, 9 or a predetermined distance from the first and second positions 6, 9. For example, if the first area 10 has a rectangular shape, the sides of the rectangle may initially be positioned a distance away from the first and second positions 6, 9, e.g. a distance between 1-10 centimetres. If the first area 10 has a circular shape, the border of the circle may initially be positioned a distance between 1-10 centimetres from the first and second positions, respectively.

Depending on user preference, any of the described alternatives may be set beforehand. If the first and second objects 5, 8 are moved against each other, the distance between the objects 5, 8 decreases. Correspondingly, if the user moves the first and second objects 5, 8 apart from each other, the distance between the objects 5, 8 increases. The gesture interpretation unit 13 is thus configured to compare the distance between the first and second objects 5, 8, i.e. the distance between the first and second positions 6, 9 of the objects 5, 8, with the determined distance in a previous time step, and to generate signals to increase or decrease the size of the first area 10 in response to the result of the comparison. These signals are illustrated as s_{z} in FIG. 1. According to one embodiment, the size of the first area 10 is increased or decreased, respectively, to a size based on the distance between the first and second objects 5, 8. Thus, the size of the first area 10 may be increased or decreased in relation to the increase or decrease of the distance between the objects 5, 8. The relationship may be a direct relationship, thus, the size of the first area 10 is changed in accordance with the movement of the objects 5, 8. The relationship may e.g. instead be exponential. Preferably the first area 10 is increased and decreased, respectively, in the same scale in all directions such that the content of the first area 10 does not become corrupt.

As illustrated in the flowchart of FIG. 2, the user now presses on the touch surface 14 with one or both of the first and the second objects 5, 8 (A7). The pressure is detected by the touch control unit 15 (FIG. 1) and the gesture interpretation unit 13 then determines from the touch input data that an increased pressure compared to a threshold of at least one of the first and second touch inputs 4, 7 has occurred (A8). The determined increase in pressure halts the increasing or the decreasing the size of the first area 10 of the graphical element 1 (A9), and a distance d₂ between the first and second objects 5, 8 is determined (A10). In a further step A11 it is determined if the distance between the first and second objects 5, 8 has decreased compared to the distance d₂ (A11), and if so the first area 10 of the graphical element 1 is cropped in relation to the decrease of the distance d₂, whereby a cropped element 23 of the graphical element 1 is defined (A12).

The cropped element 23 now defines a selected view and in some embodiments a zoomed in view of a certain detail of the graphical element 1. The cropped element 23 can e.g. now be moved to a certain location by pointing with an object on the cropped element 23 and moving the element 23 in accordance with the movement of the object. The cropped element 23 may instead be dragged and dropped to a certain location.

In step A12 the first area 10 of the graphical element 1 may be cropped in relation to the attained decreased distance upon determining from the touch input data that an increased pressure compared to a threshold of at least one of the first and second touch inputs 4, 7 has occurred. Thus, first when the user in this step presses on the touch surface 14 with the first and/or the second objects 5, 8, the cropped element 23 is defined. According to another embodiment, the first area 10 of the graphical element 1 is cropped in relation to the attained decreased distance upon determining from the touch input data that at least one of the first and second objects 5, 8 is not present anymore on the touch surface 14. Thus, if any or both of the first and second objects 5, 8 makes a “touch up”, thus leaves the touch surface 14, the cropped element 23 is defined. According to a further embodiment, the method comprises continuously cropping the first area 10 of the graphical element 1 in accordance with the decreased distance. The user may then continuously see how large the cropped element 23 will be.

As a response to the increased pressure, or if a “touch up” is made as described, the cropped element 23 may automatically be transferred to a certain location.

To make it easier for the user to see the various areas during zooming (zoom in and zoom out) and cropping, the areas and/or their surroundings may be visually indicated. For example, the method may comprise to visually indicate the first area 10, and/or the cropped element 23. The visual indication may for example include presenting a frame around any of the areas. According to one embodiment, the method comprises visually presenting the first area 10 of the graphical element 1 in relation to the cropped element 23 of the graphical element 1. The cropped element 23 will thus be a subset of the first area 10 of the graphical element 1, and the area between the cropped element and the first area 10 may thus be visually indicated to emphasise the cropped element 23. For example may the area be coloured, e.g. in grey, white or any other colour.

FIGS. 3A-3F illustrates the touch surface 14 of various points of performance of the method according to some embodiments of the invention. The touch surface 14 is part of the touch arrangement 2 (FIG. 1), and is here provided with a frame 24 as illustrated in the figures. Some embodiments of the method will now be exemplified with reference to the FIGS. 3A-3F. In FIG. 3A the graphical element 1, here in the shape of an image of a house, is presented via the GUI and is visible from the touch surface 14. The touch surface 14 may e.g. be overlaid a display, or the touch surface 14 may be part of a display as explained before. The display is then capable of displaying graphics via a GUI of an operating system of the touch sensing device 3. A user now makes a first touch input 4 by placing a first finger 5 at the touch surface 14. Via the touch input data a first position 6 can be determined for the first finger 5. The user makes a second touch input 7 by placing a second finger 8 at the touch surface 14, whereby a second position 9 on the touch surface 14 can be determined for the second finger 8. The fingers 5, 8 are present on the touch surface 14 during overlapping time periods, and while the fingers 5, 8 are maintained on the touch surface 14, a distance d₁ is determined between the positions 6, 9. The distance d₁ is indicated in FIG. 3A, as well as a first area 10 of the graphical element 1. The first area 10 here corresponds to the area of the graphical element 1, here thus the image of the house.

As illustrated in FIG. 3B, the user now moves the fingers 5, 8 against each other, whereby the distance between the fingers 5, 8 decreases. The distance is denoted “d” in the figure. The first area 10 is then decreased in response to the decrease in distance, here in direct relationship to the decrease in distance. This action is also referred to as “zooming out”. As can be seen in FIG. 3B, the content of the first area is zoomed out, thus scaled down. The user hereafter moves the fingers 5, 8 apart from each other as illustrated in FIG. 3C, whereby the distance between the fingers 5, 8 increases. The first area 10 is then increased in response to the increase in distance, here in direct relationship to the increase in distance. This action is also referred to as “zooming in”. As can be seen in FIG. 3C, the content of the first area is zoomed in, thus scaled up.

The user is now satisfied with the enlargement of the first area 10, and presses with both fingers 5, 8, against the touch surface 14 with the pressures P1 and P2 as illustrated in FIG. 3D. This action halts, i.e. stops, the possibility of zooming the first area 10 more, and a distance d₂ between the fingers 5, 8 is determined. The distance d₂ is thus determined to be between the positions of the fingers 5, 8 at the same time instance as the pressures P1 and P2 are determined. The user now moves the fingers 5, 8 against each other as illustrated in FIG. 3E such that the distance between the fingers 5, 8, denoted “d” in the figure, decreases. The distance d thus decreases compared to the beforehand determined distance d₂. The first area 10 is here cropped in direct relationship to the decreased distance. When the user is satisfied with the cropping, he lifts his fingers 5, 8 from the touch surface 14 and thereby a cropped element 23 of the graphical element 1 is defined as shown in FIG. 3F.

3. Touch Technology Based on FTIR

As explained before, the invention can be used together with several kinds of touch technologies. One kind of touch technology based on FTIR will now be explained. The touch technology can advantageously be used together with the invention to deliver touch input data xₙₜ, yₙₜ, pₙₜ to the processor 12 of the gesture interpretation unit 13 (FIG. 1).

In FIG. 4A a side view of an exemplifying arrangement 27 for sensing touches in a known touch sensing device is shown. The arrangement 27 may e.g. be part of the touch arrangement 2 illustrated in FIG. 1A. The arrangement 27 includes a light transmissive panel 25, a light transmitting arrangement comprising one or more light emitters 19 (one shown) and a light detection arrangement comprising one or more light detectors 20 (one shown). The panel 25 defines two opposite and generally parallel top and bottom surfaces 28, 18 and may be planar or curved. In FIG. 4A, the panel 25 is rectangular, but it could have any extent. A radiation propagation channel is provided between the two boundary surfaces 28, 18 of the panel 25, wherein at least one of the boundary surfaces 28, 18 allows the propagating light to interact with one or several touching object 21, 22. Typically, the light from the emitter(s) 19 propagates by total internal reflection (TIR) in the radiation propagation channel, and the detector(s) 20 are arranged at the periphery of the panel 25 to generate a respective output signal which is indicative of the energy of received light.

As shown in the FIG. 4A, the light may be coupled into and out of the panel 25 directly via the edge portions of the panel 25 which connects the top 28 and bottom surfaces 18 of the panel 25. The previously described touch surface 14 is according to one embodiment at least part of the top surface 28. The detector(s) 20 may instead be located below the bottom surface 18 optically facing the bottom surface 18 at the periphery of the panel 25. To direct light from the panel 25 to the detector(s) 20, coupling elements might be needed. The detector(s) 20 will then be arranged with the coupling element(s) such that there is an optical path from the panel 25 to the detector(s) 20. In this way, the detector(s) 20 may have any direction to the panel 25, as long as there is an optical path from the periphery of the panel 25 to the detector(s) 20. When one or several objects 21, 22 is/are touching a boundary surface of the panel 25, e.g. the touch surface 14, part of the light may be scattered by the object(s) 21, 22, part of the light may be absorbed by the object(s) 21, 22 and part of the light may continue to propagate unaffected. Thus, when the object(s) 21, 22 touches the touch surface 14, the total internal reflection is frustrated and the energy of the transmitted light is decreased. This type of touch-sensing apparatus is denoted “FTIR system” (FTIR—Frustrated Total Internal Reflection) in the following. A display may be placed under the panel 25, i.e. below the bottom surface 18 of the panel. The panel 25 may instead be incorporated into the display, and thus be a part of the display.

The location of the touching objects 21, 22 may be determined by measuring the energy of light transmitted through the panel 25 on a plurality of detection lines. This may be done by e.g. operating a number of spaced apart light emitters 19 to generate a corresponding number of light sheets into the panel 25, and by operating the light detectors 20 to detect the energy of the transmitted energy of each light sheet. The operating of the light emitters 19 and light detectors 20 may be controlled by a touch processor 26. The touch processor 26 is configured to process the signals from the light detectors 20 to extract data related to the touching object or objects 21, 22. The touch processor 26 is part of the touch control unit 15 as indicated in the figures. A memory unit (not shown) is connected to the touch processor 26 for storing processing instructions which, when executed by the touch processor 26, performs any of the operations of the described method.

The light detection arrangement may according to one embodiment comprise one or several beam scanners, where the beam scanner is arranged and controlled to direct a propagating beam towards the light detector(s).

As indicated in FIG. 4A, the light will not be blocked by a touching object 21, 22. If two objects 21 and 22 happen to be placed after each other along a light path from an emitter 19 to a detector 20, part of the light will interact with both these objects 21, 22. Provided that the light energy is sufficient, a remainder of the light will interact with both objects 21, 22 and generate an output signal that allows both interactions (touch inputs) to be identified. Normally, each such touch input has a transmission in the range 0-1, but more usually in the range 0.7-0.99. The total transmission t, along a light path i is the product of the n individual transmissions tₖ of the touch points on the light path: tᵢ=Πₖ₌₁ⁿ tₖ. Thus, it may be possible for the touch processor 26 to determine the locations of multiple touching objects 21, 22, even if they are located in the same line with a light path.

FIG. 4B illustrates an embodiment of the FTIR system, in which a light sheet is generated by a respective light emitter 19 at the periphery of the panel 25. Each light emitter 19 generates a beam of light that expands in the plane of the panel 25 while propagating away from the light emitter 19. Arrays of light detectors 20 are located around the perimeter of the panel 25 to receive light from the light emitters 19 at a number of spaced apart outcoupling points within an outcoupling site on the panel 25. As indicated by dashed lines in FIG. 4B, each sensor-emitter pair 19, 20 defines a detection line. The light detectors 20 may instead be placed at the periphery of the bottom surface 18 of the touch panel 25 and protected from direct ambient light propagating towards the light detectors 20 at an angle normal to the touch surface 14. One or several detectors 20 may not be protected from direct ambient light, to provide dedicated ambient light detectors.

The detectors 20 collectively provide an output signal, which is received and sampled by the touch processor 26. The output signal contains a number of sub-signals, also denoted “projection signals”, each representing the energy of light emitted by a certain light emitter 19 and received by a certain light sensor 20. Depending on implementation, the processor 26 may need to process the output signal for separation of the individual projection signals. As will be explained below, the processor 26 may be configured to process the projection signals so as to determine a distribution of attenuation values (for simplicity, referred to as an “attenuation pattern”) across the touch surface 14, where each attenuation value represents a local attenuation of light.

4. Data Extraction Process in an FTIR System

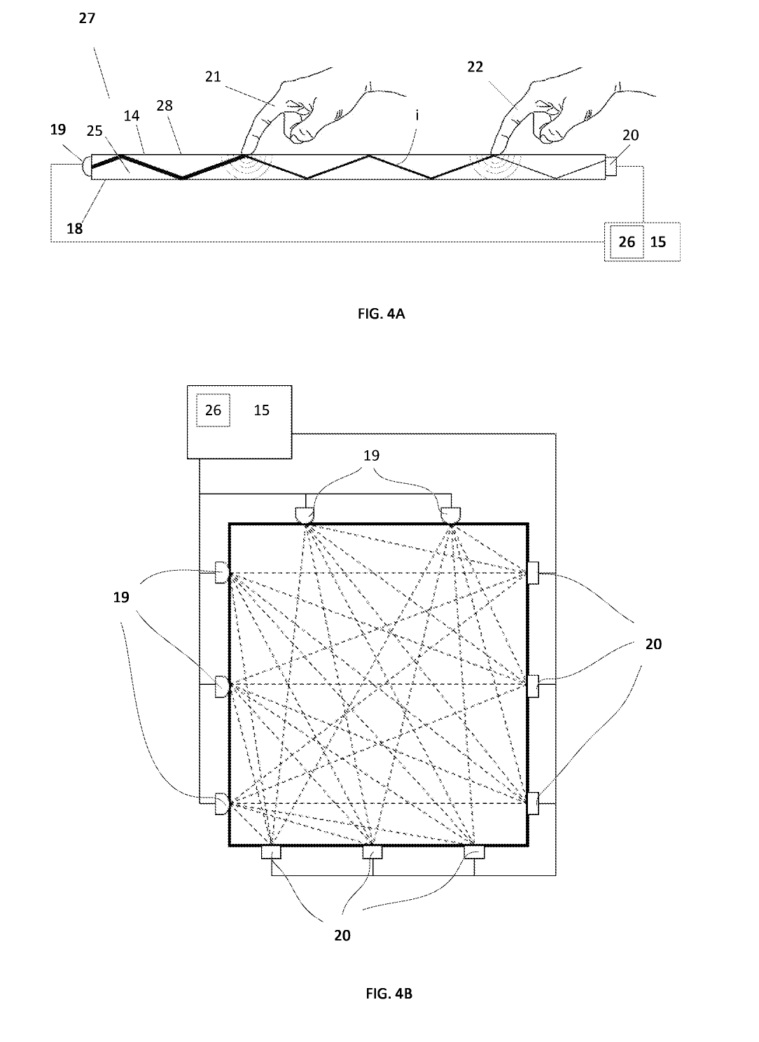

FIG. 5 is a flow chart of a data extraction process in an FTIR system. The process involves a sequence of steps B1-B4 that are repeatedly executed, e.g. by the touch processor 26 (FIG. 4A). In the context of this description, each sequence of steps B1-B4 is denoted a frame or iteration. The process is described in more detail in the Swedish application No 1251014-5, filed on Sep. 11, 2012, which is incorporated herein in its entirety by reference.

Each frame starts by a data collection step B1, in which measurement values are obtained from the light detectors 20 in the FTIR system, typically by sampling a value from each of the aforementioned projection signals. The data collection step B1 results in one projection value for each detection line. It may be noted that the data may, but need not, be collected for all available detection lines in the FTIR system. The data collection step B1 may also include pre-processing of the measurement values, e.g. filtering for noise reduction.

In a reconstruction step B2, the projection values are processed for generation of an attenuation pattern. Step B2 may involve converting the projection values into input values in a predefined format, operating a dedicated reconstruction function on the input values for generating an attenuation pattern, and possibly processing the attenuation pattern to suppress the influence of contamination on the touch surface (fingerprints, etc.).

In a peak detection step B3, the attenuation pattern is then processed for detection of peaks, e.g. using any known technique. In one embodiment, a global or local threshold is first applied to the attenuation pattern, to suppress noise. Any areas with attenuation values that fall above the threshold may be further processed to find local maxima. The identified maxima may be further processed for determination of a touch shape and a center position, e.g. by fitting a two-dimensional second-order polynomial or a Gaussian bell shape to the attenuation values, or by finding the ellipse of inertia of the attenuation values. There are also numerous other techniques as is well known in the art, such as clustering algorithms, edge detection algorithms, standard blob detection, water shedding techniques, flood fill techniques, etc. Step B3 results in a collection of peak data, which may include values of position, attenuation, size, and shape for each detected peak. The attenuation may be given by a maximum attenuation value or a weighted sum of attenuation values within the peak shape.

In a matching step B4, the detected peaks are matched to existing traces, i.e. traces that were deemed to exist in the immediately preceding frame. A trace represents the trajectory for an individual touching object on the touch surface as a function of time. As used herein, a “trace” is information about the temporal history of an interaction. An “interaction” occurs when the touch object affects a parameter measured by a sensor. Touches from an interaction detected in a sequence of frames, i.e. at different points in time, are collected into a trace. Each trace may be associated with plural trace parameters, such as a global age, an attenuation, a location, a size, a location history, a speed, etc. The “global age” of a trace indicates how long the trace has existed, and may be given as a number of frames, the frame number of the earliest touch in the trace, a time period, etc. The attenuation, the location, and the size of the trace are given by the attenuation, location and size, respectively, of the most recent touch in the trace. The “location history” denotes at least part of the spatial extension of the trace across the touch surface, e.g. given as the locations of the latest few touches in the trace, or the locations of all touches in the trace, a curve approximating the shape of the trace, or a Kalman filter. The “speed” may be given as a velocity value or as a distance (which is implicitly related to a given time period). Any known technique for estimating the tangential speed of the trace may be used, taking any selection of recent locations into account. In yet another alternative, the “speed” may be given by the reciprocal of the time spent by the trace within a given region which is defined in relation to the trace in the attenuation pattern. The region may have a pre-defined extent or be measured in the attenuation pattern, e.g. given by the extent of the peak in the attenuation pattern.

The matching step B4 may be based on well-known principles and will not be described in detail. For example, step B4 may operate to predict the most likely values of certain trace parameters (location, and possibly size and shape) for all existing traces and then match the predicted values of the trace parameters against corresponding parameter values in the peak data produced in the peak detection step B3. The prediction may be omitted. Step B4 results in “trace data”, which is an updated record of existing traces, in which the trace parameter values of existing traces are updated based on the peak data. It is realized that the updating also includes deleting traces deemed not to exist (caused by an object being lifted from the touch surface 14, “touch up”), and adding new traces (caused by an object being put down on the touch surface 14, “touch down”).

Following step B4, the process returns to step B1. It is to be understood that one or more of steps B1-B4 may be effected concurrently. For example, the data collection step B1 of a subsequent frame may be initiated concurrently with any one of the steps B2-B4.

The result of the method steps B1-B4 is trace data, which includes data such as positions (xₙₜ, yₙₜ) for each trace. This data has previously been referred to as touch input data.

5. Detect Pressure The current attenuation of the respective trace can be used for estimating the current application force for the trace, i.e. the force by which the user presses the corresponding touching object against the touch surface. The estimated quantity is often referred to as a “pressure”, although it typically is a force. The process is described in more detail in the above-mentioned application No. 1251014-5. It should be recalled that the current attenuation of a trace is given by the attenuation value that is determined by step B2 (FIG. 5) for a peak in the current attenuation pattern.

According to one embodiment, a time series of estimated force values is generated that represent relative changes in application force over time for the respective trace. Thereby, the estimated force values may be processed to detect that a user intentionally increases or decreases the application force during a trace, or that a user intentionally increases or decreases the application force of one trace in relation to another trace.

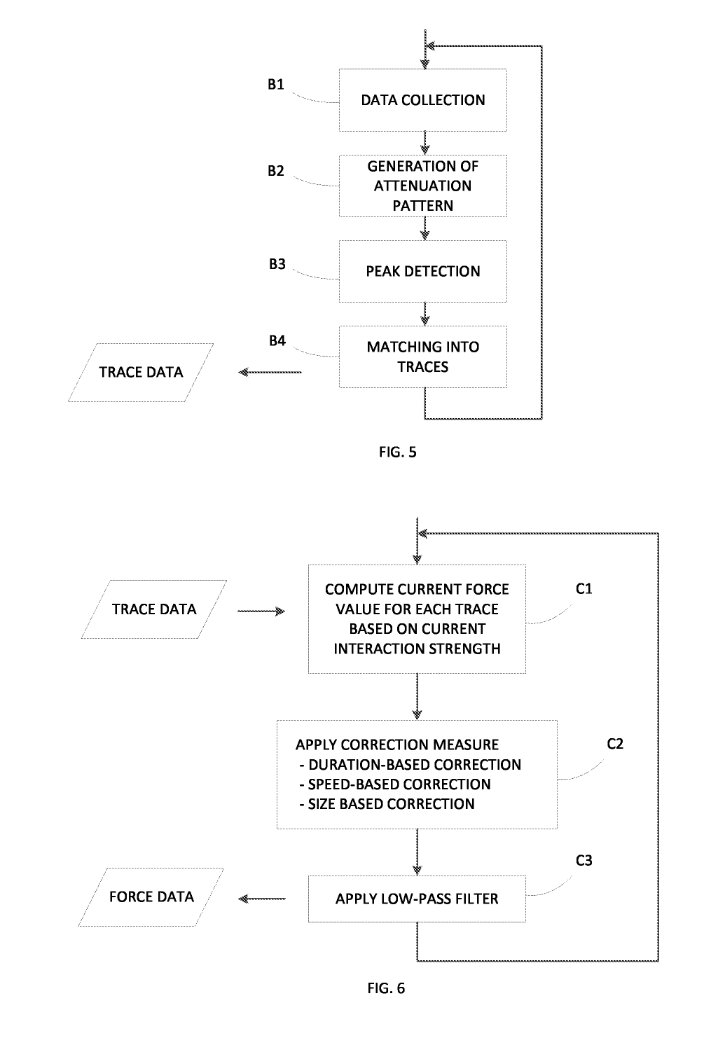

FIG. 6 is a flow chart of a force estimation process according to one embodiment. The force estimation process operates on the trace data provided by the data extraction process in FIG. 5. It should be noted that the process in FIG. 6 operates in synchronization with the process in FIG. 5, such that the trace data resulting from a frame in FIG. 5 is then processed in a frame in FIG. 6. In a first step C1, a current force value for each trace is computed based on the current attenuation of the respective trace given by the trace data. In one implementation, the current force value may be set equal to the attenuation, and step C1 may merely amount to obtaining the attenuation from the trace data. In another implementation, step C1 may involve a scaling of the attenuation. Following step C1, the process may proceed directly to step C3. However, to improve the accuracy of the estimated force values, step C2 applies one or more of a number of different corrections to the force values generated in step C1. Step C2 may thus serve to improve the reliability of the force values with respect to relative changes in application force, reduce noise (variability) in the resulting time series of force values that are generated by the repeated execution of steps C1-C3, and even to counteract unintentional changes in application force by the user. As indicated in FIG. 6, step C2 may include one or more of a duration correction, a speed correction, and a size correction. The low-pass filtering step C3 is included to reduce variations in the time series of force values that are produced by step C1/C2. Any available low-pass filter may be used.

Thus, each trace now also has force values, thus, the trace data includes positions (xₙₜ, yₙₜ) and forces (also referred to as pressure) (pₙₜ) for each trace. These data can be used as touch input data to the gesture interpretation unit 13 (FIG. 1).

The present invention is not limited to the above-described preferred embodiments. Various alternatives, modifications and equivalents may be used. Therefore, the above embodiments should not be taken as limiting the scope of the invention, which is defined by the appending claims.

1. A method, comprising:
receiving touch input data indicating touch inputs on a touch surface of a touch sensing device, and determining from said touch input data:
a first touch input from a first object at a first position on the touch surface, and
a second touch input from a second object at a second position on the touch surface and while continuous contact of said first and second objects with the touch surface is maintained:
determining from said touch input data a distance d₁ between the first and second objects, and increasing the size of a first area of a graphical element visible via the touch surface if the distance increases, and decreasing the size of the first area of graphical element if the distance decreases;
determining from said touch input data that an increased pressure compared to a threshold of at least one of the first and second touch inputs has occurred, and thereby:
halting the increasing or the decreasing the size of the first area of the graphical element; and
determining a distance d₂ between the first and second objects;
determining from said touch input data that the distance between the first and second objects has decreased compared to the distance d₂, and
cropping the first area of the graphical element in relation to the decrease of the distance, whereby a cropped element of the graphical element is defined.

2. The method according to claim 1, comprising cropping the first area of the graphical element in relation to the attained decreased distance upon determining from said touch input data that an increased pressure compared to a threshold of at least one of the first and second touch inputs has occurred.

3. The method according to claim 1, comprising cropping the first area of the graphical element in relation to the attained decreased distance upon determining from said touch input data that at least one of the first and second objects is not present anymore on the touch surface.

4. The method according to claim 1, comprising continuously cropping the first area of the graphical element in accordance with the decreased distance.

5. The method according to claim 1, wherein increasing or decreasing the size comprises increasing or decreasing the size of the first area to a size based on the distance between the first and second objects.

6. The method according to claim 1, comprising visually indicating the first area.

7. The method according to claim 6, wherein visually indicating the first area comprises visually presenting the first area of the graphical element in relation to the cropped element of the graphical element.

8. The method according to claim 1, wherein said touch input data comprises positioning data xₙₜ, yₙₜ for the first and second touch input.

9. A computer readable storage medium comprising computer programming instructions which, when executed on a processor, are configured to carry out the method of claim 1.

10. A gesture interpretation unit comprising a processor configured to receive a touch signal sₓ comprising touch input data indicating touch inputs on a touch surface of a touch sensing device, the gesture interpretation unit further comprising a computer readable storage medium storing instructions operable to cause the processor to perform operations comprising:
determining from said touch input data:
a first touch input from a first object at a first position on the touch surface, and
a second touch input from a second object at a second position on the touch surface; and while continuous contact of said first and second objects with the touch surface is maintained:
determining from said touch input data a distance d₁ between the first and second objects, generating a first signal for increasing the size of a first area of a graphical element visible via the touch surface if the distance increases, and generating a second signal for decreasing the size of the first area of the graphical element if the distance decreases;
determining from said touch input data that an increased pressure compared to a threshold of at least one of the first and second touch inputs has occurred, and thereby:
halting generating any of the first and the second signal for increasing and decreasing the size of the first area of the graphical element, respectively;
determining a distance d₂ between the first and second objects;
determining from said touch input data that the distance between the first and second objects has decreased compared to the distance d₂, and
cropping the first area of the graphical element in relation to the decrease of the distance, whereby a cropped element of the graphical element is defined.

11. The unit according to claim 10, comprising instructions for cropping the first area of the graphical element in relation to the attained decreased distance upon determining from said touch input data that an increased pressure compared to a threshold of at least one of the first and second touch inputs has occurred.

12. The unit according to claim 10, comprising instructions for cropping the first area of the graphical element in relation to the attained decreased distance upon determining from said touch input data that at least one of the first and second objects is not present anymore on the touch surface.

13. The unit according to claim 10, comprising instructions for continuously cropping the first area of the graphical element in accordance with the decreased distance.

14. The unit according to claim 10, comprising instructions for generating the first signal for increasing the size of the first area to a size defined by the positions of the first and second objects.

15. The unit according to claim 10, comprising instructions for -generating the second signal for decreasing the size of the first area to a size defined by the positions of the first and second objects.

16. The unit according to claim 10, wherein the touch input data comprises positioning data xₙₜ, yₙₜ for the first and second touch inputs.

17. The unit according to claim 10, comprising instructions for visually indicating the first area.

18. The unit according to claim 17, comprising instructions for visually presenting the first area in relation to the cropped element of the graphical element on the touch surface.

19. The unit according to claim 10, comprising instructions for generating a signal for visually presenting the cropped element on the touch surface.

20. The unit according to claim 10, wherein the touch sensing device is a Frustrated Total Internal Reflection, FTIR, -based touch sensing device.

21. A touch sensing device comprising
a touch surface;
a touch control unit configured to determine touch input data from touch input on said touch surface, and generate a touch signal sₓ indicating the touch input data; and
a gesture interpretation unit according to claim 10, wherein the gesture interpretation unit is configured to receive said touch signal sₓ.
